(19) United States
(12) Patent Application Publication
(10) Pub. No.: US 2018/0266574 A1
(43) Pub. Date: Sep. 20, 2018

(54) DRINKING STRAW DIAPHRAGM

(71) Applicant: Tyrone Wilson, SR., Washington, NC (US)

(72) Inventor: Tyrone Wilson, SR., Washington, NC (US)

(21) Appl. No.: 15/460,587

(22) Filed: Mar. 16, 2017

(51) Int. Cl. F16K 7/02; A47G 21/18

(52) U.S. Cl. CPC F16K 7/02; A47G 21/181

(57) ABSTRACT

A drinking straw diaphragm is provided. The drinking straw diaphragm may provide a body circumscribing a flow opening fluidly communicative to straw portions on opposing end of the body. The flow opening is defined by opposing first and second edges cut through the body, wherein the first and second edges are biased in an open condition, but selectively movable between the open condition and the closed condition wherein the first and second edges engage, substantially reducing the flow opening in a controllable manner.

### BACKGROUND OF THE INVENTION

The present invention relates to drinking straws and, more particularly, a drinking straw diaphragm.

Drinking straws are well known in the art and are effective means for drinking liquids from glasses and other containers. One of the problems, however, commonly associated with convention straws is the difficulty of controlling the volume of liquid flowing through the straw; chiefly, consistently maintaining a desire volume of flow. Typically, such control is imposed through providing lesser or greater air pressure inside the straw, but inconsistent, too much or too little, are the norm. This deficiency rears its head when, for example, a fluid is hot and so a user only desires a controlled, diminished amount to be delivered through the straw. The only solution is providing a straw for such condition and at least another straw for sipping cooler fluids they desire as much as possible.

As can be seen, there is a need for a drinking straw diaphragm that can be connected to a straw so as to selectively control the volume of fluid flowing through the straw, whereby one straw is the only one needed for different circumstances.

### SUMMARY OF THE INVENTION

In one aspect of the present invention, a drinking straw diaphragm includes a body circumscribing a flow opening, wherein the flow opening is defined by opposing first and second edges extending a length of the body, the body being movable between an open condition and a closed condition mating the opposing first and second edges, wherein the body is biased in the open condition; and two straw portions, one of the two straw portions extending from each of the opposing ends of the body, wherein the two straw portions and the flow opening are fluidly communicative.

In another aspect of the present invention, the drinking straw diaphragm includes a body circumscribing a flow opening, wherein the flow opening is defined by opposing first and second edges extending a length of the body, the body being movable between an open condition and a closed condition mating the opposing first and second edges, wherein the body is biased in the open condition, and wherein the opposing first and second edges provide cooperating saw-tooth configurations that mate in the closed condition; two straw portions, one of the two straw portions extending from each of the opposing ends of the body, wherein the two straw portions and the flow opening are fluidly communicative; a plurality of spaced apart grips extending along an outer surface of the body; a radial spout provided along a distal end of one of the two straw portions; and a spoon provided along a distal end of the other of the two straw portions, wherein a plurality of diaphragm holes extending the length of the body, wherein the plurality of diaphragm holes remain fluidly communicative in the closed condition, and/or wherein one of the opposing first and second edges provides a void saw-tooth that defines the flow opening in the closed condition.

In yet another aspect of the present invention, the drinking straw diaphragm includes a body circumscribing a flow opening, wherein the flow opening is defined by opposing first and second edges extending a length of the body, the body being movable between an open condition and a closed condition mating the opposing first and second edges, wherein the body is biased in the open condition, and wherein the opposing first and second edges provide cooperating saw-tooth configurations that mate in the closed condition; a plurality of spaced apart grips extending along an outer surface of the body; and peripheral extensions extending from each opposing end of the body, wherein each peripheral extension defines a cavity about the respective end of the body.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a section view of an exemplary embodiment of the present invention, taken along line 2-2 in FIG. 1;

FIG. 3 is a section view of an exemplary embodiment of the present invention, taken along line 3-3 in FIG. 1;

FIG. 4 is a section view of an exemplary embodiment of the present invention, illustrating the narrowing of a flow opening when a diaphragm is in a closed condition;

FIG. 5 is a perspective view of an exemplary embodiment of the present invention;

FIG. 6 is a section view of an exemplary embodiment of the present invention, taken along line 6-6 in FIG. 5;

FIG. 7 is a section view of an exemplary embodiment of the present invention, illustrating the narrowing of the flow opening when the diaphragm in the closed condition;

FIG. 8 is a perspective view of an exemplary embodiment of the present invention;

FIG. 9 is an exploded view of an exemplary embodiment of the present invention; and

FIG. 10 is a section view of an exemplary embodiment of the present invention, taken along line 10-10 in FIG. 8.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a drinking straw diaphragm. The drinking straw diaphragm may provide a body circumscribing a flow opening fluidly communicative to straw portions on opposing end of the body. The flow opening is defined by opposing first and second edges cut through the body, wherein the first and second edges are biased in an open condition, but selectively movable between the open condition and the closed condition wherein the first and second edges engage, substantially reducing the flow opening in a controllable manner.

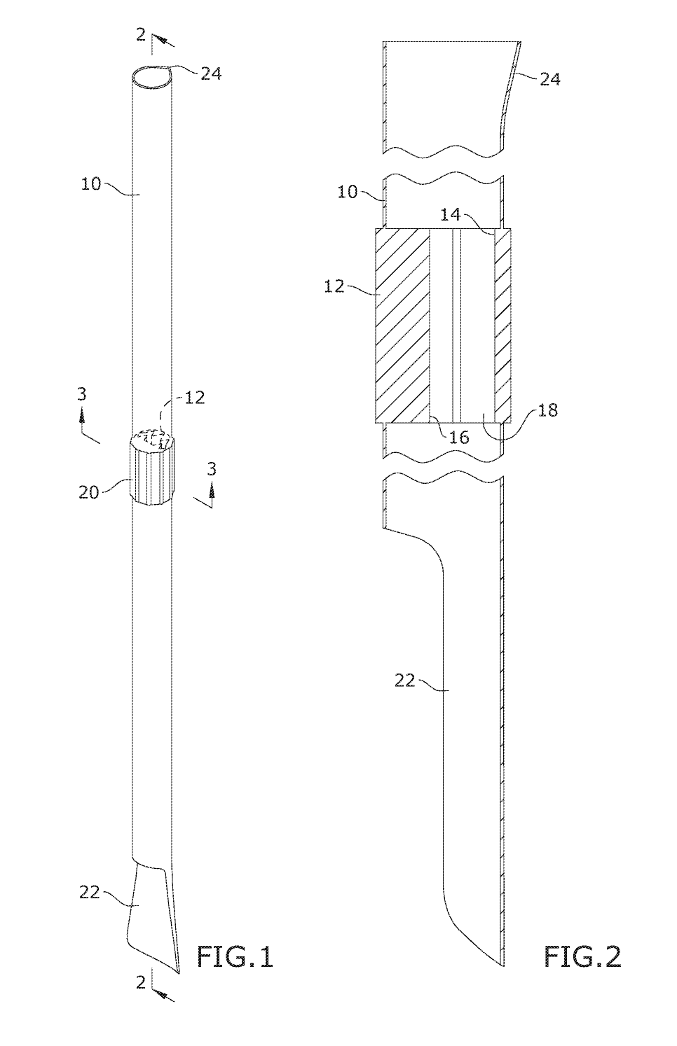

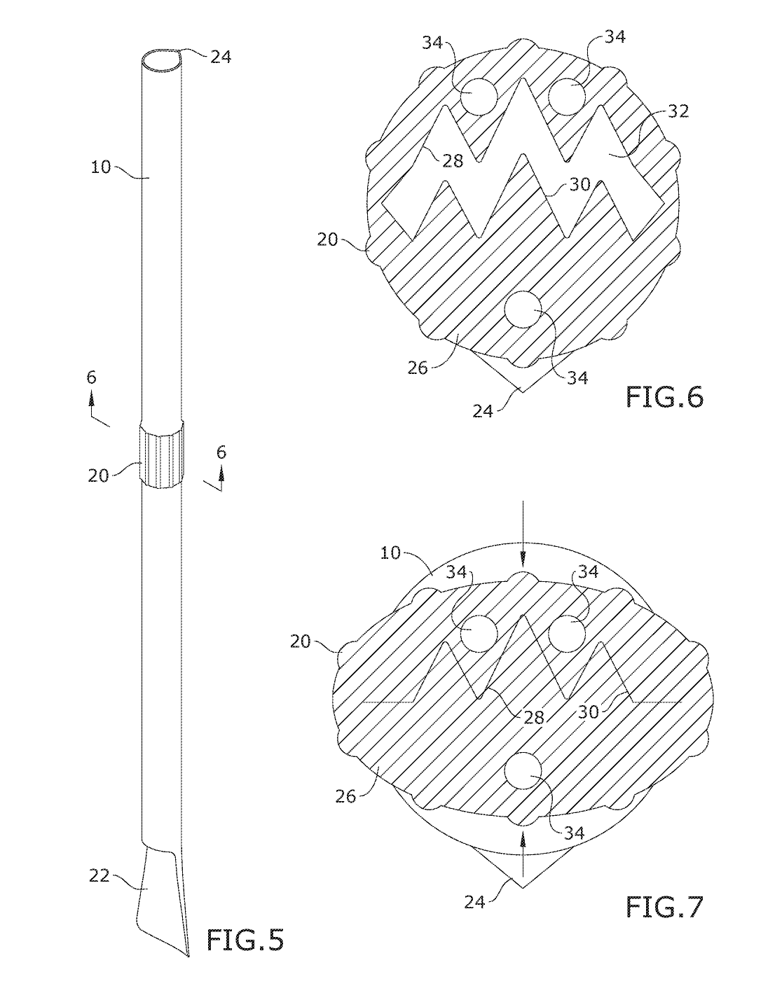

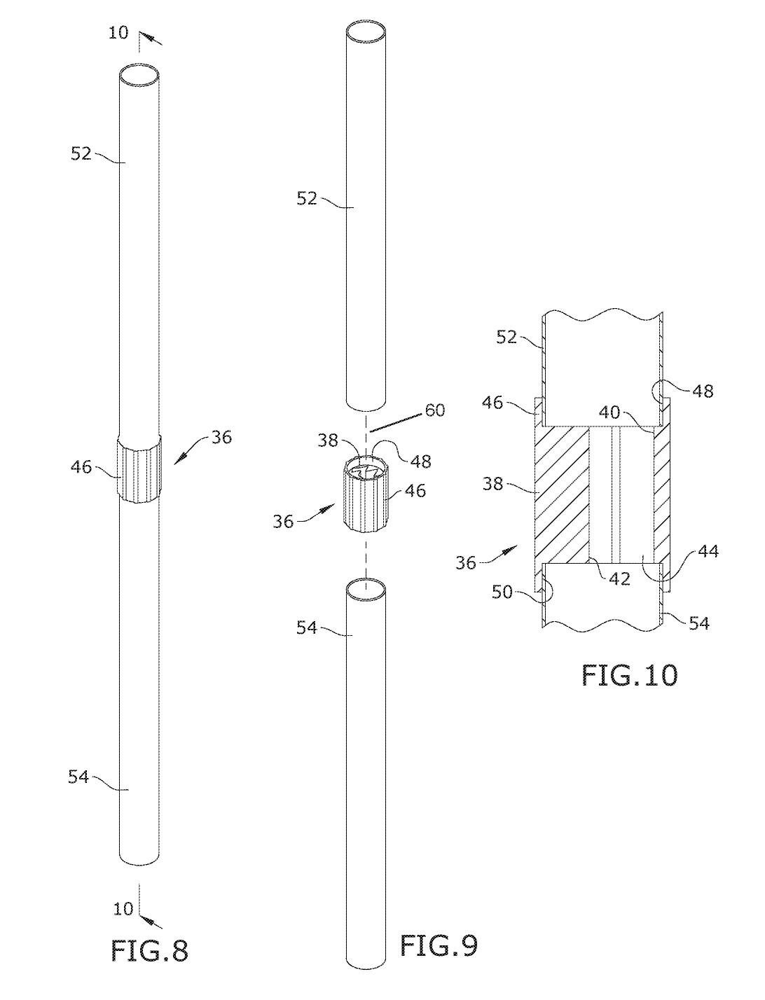

Referring to FIGS. 1 through 10, the present invention provides a straw diaphragm 12, 26, 38 that may be integrated with or removably attached to a straw portion 10 so as to be fluidly communicative therewith. It being understood that the straw portion 10 may have a cylindrical elongated tube with a hollow center with two open ends. In certain embodiments, the straw portion 10 may provide a spout 24 on one end, wherein the spout 24 extends radially outward from the associated opening, as illustrated in FIGS. 1 and 2. In certain embodiments, the straw portion 10 may provide a spoon 22 on one end, wherein the spoon 22 includes a portion of the tube wall extending farther than a remaining portion thereof, as illustrated in FIGS. 1 and 2.

When integrated into the straw portion 10, the diaphragm 12, 26 is disposed between the two open ends. When removably attached, the present invention is a standalone device 36 having a diaphragm 38 that provides peripheral extensions 48, 50 on each opposing end, wherein each peripheral extension 48, 50 is adapted to extend around the outer surface of a respective end 52, 54 of two different straw portions 10, thereby holding the device 36 in place via a snug friction force between the inner surface of the peripheral extension 48, 50 and outer surface of the straw portion 10.

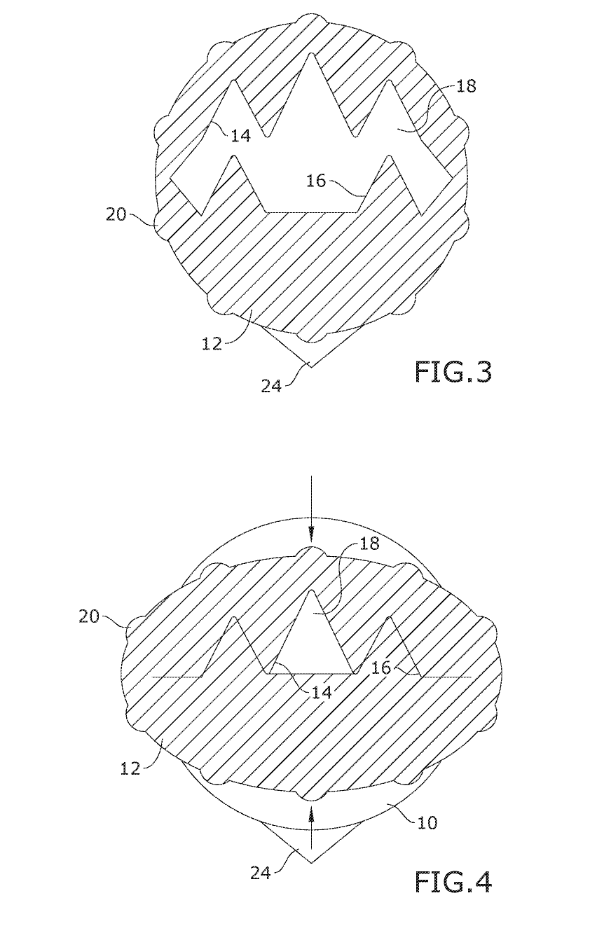

Each diaphragm 12, 26, 38 includes a body of material providing a flow opening 18, 32, 44 defined by a first edge 14, 28, 40 and an opposing second edge 16, 30, 42, wherein said first and second edges are movable between an open condition (FIGS. 3 and 6) and a closed condition (FIGS. 4 and 7). In the closed condition, said first and second edges mate, reducing the flow opening 18 by up to 90 percent. In a first embodiment 12 of the diaphragm, the first and second edges 14, 16 may provide saw-tooth configurations, wherein a “missing” tooth on one of the edges amounts to the flow opening 18 in the closed condition, as illustrated in FIG. 4. In an alternative embodiment, the diaphragm 26 may have a saw-tooth configuration with no “missing” tooth, but rather the body portion would provide a plurality of diaphragm holes 34 that are fluidly communicative through the diaphragm 26. In such an embodiment, the totality of the plurality of diaphragm holes 34 provide are about ten percent in surface area relative to the flow opening 18 in the open condition; in the closed condition, the flow opening 18 is completely closed.

Each diaphragm 12, 26, 38 includes elongated grips 20, 46 along an outer surface thereof, extending in the direction of the longitudinal axis 60 of each diaphragm 12, 26, 38. The body of each diaphragm may be biased in the open condition, but elastic enough so that the outer surface generally offset from the first or second edge may be urged inward, depicted with the arrows in FIGS. 4 and 7, moving the diaphragm body to the closed condition.

A method of using the present invention may include the following. The straw diaphragm 12, 26, 38 disclosed above may be provided. A user may manually urge the diaphragm 12, 26, 38 to selectively move the flow opening 18 anywhere between the open and closed condition, so that when the user decreases the pressure within the hollow center of the straw portion(s) 10, and thus the flow opening 18 of the diaphragm 12, 26, 38 fluidly communicative therewith, the flow of fluid is controlled.

It should be understood, of course, that the foregoing relates to exemplary embodiments of the invention and that modifications may be made without departing from the spirit and scope of the present invention.

1. A device, comprising:
a body circumscribing a flow opening, wherein the flow opening is defined by opposing first and second edges extending a length of the body,
the body being movable between an open condition and a closed condition mating the opposing first and second edges, wherein the body is biased in the open condition; and
two straw portions, one of the two straw portions extending from each of the opposing ends of the body, wherein the two straw portions and the flow opening are fluidly communicative.

2. The device of claim 1, further comprising a plurality of spaced apart grips extending along an outer surface of the body.

3. The device of claim 1, further comprising a radial spout provided along a distal end of one of the two straw portions.

4. The device of claim 1, further comprising a spoon provided along a distal end of one of the two straw portions.

5. The device of claim 1, further comprising a plurality of diaphragm holes extending the length of the body, wherein the plurality of diaphragm holes remain fluidly communicative in the closed condition.

6. The device of claim 1, wherein the opposing first and second edges provide cooperating saw-tooth configurations that mate in the closed condition.

7. The device of claim 6, wherein one of the opposing first and second edges provides a void saw-tooth that defines the flow opening in the closed condition.

8. A device, comprising:
a body circumscribing a flow opening, wherein the flow opening is defined by opposing first and second edges extending a length of the body,
the body being movable between an open condition and a closed condition mating the opposing first and second edges, wherein the body is biased in the open condition, and wherein the opposing first and second edges provide cooperating saw-tooth configurations that mate in the closed condition;
two straw portions, one of the two straw portions extending from each of the opposing ends of the body, wherein the two straw portions and the flow opening are fluidly communicative;
a plurality of spaced apart grips extending along an outer surface of the body;
a radial spout provided along a distal end of one of the two straw portions; and
a spoon provided along a distal end of the other of the two straw portions.

9. The device of claim 8, further comprising a plurality of diaphragm holes extending the length of the body, wherein the plurality of diaphragm holes remain fluidly communicative in the closed condition.

10. The device of claim 9, wherein one of the opposing first and second edges provides a void saw-tooth that defines the flow opening in the closed condition.

11. A device, comprising:
a body circumscribing a flow opening, wherein the flow opening is defined by opposing first and second edges extending a length of the body,
the body being movable between an open condition and a closed condition mating the opposing first and second edges, wherein the body is biased in the open condition, and wherein the opposing first and second edges provide cooperating saw-tooth configurations that mate in the closed condition;
a plurality of spaced apart grips extending along an outer surface of the body; and
peripheral extensions extending from each opposing end of the body, wherein each peripheral extension defines a cavity about the respective end of the body.

12. The device of claim 11, wherein the opposing first and second edges provide cooperating saw-tooth configurations that mate in the closed condition.

13. The device of claim 12, further comprising a plurality of diaphragm holes extending the length of the body, wherein the plurality of diaphragm holes remain fluidly communicative in the closed condition.

14. The device of claim 12, wherein one of the opposing first and second edges provides a void saw-tooth that defines the flow opening in the closed condition.
